(19) United States
(12) Patent Application Publication
(10) Pub. No.: US 2006/0290306 A1
(43) Pub. Date: Dec. 28, 2006

(54) Electrical circuit arrangement for a power tool

(75) Inventor: Peter Broghammer, Wurmlingen (DE)

Correspondence Address: BURR & BROWN, PO BOX 7068, SYRACUSE, NY, 13261-7068, US

(73) Assignee: Marquardt GmbH, Rietheim-Weilheim (DE)

(21) Appl. No.: 11/511,603

(22) Filed: Aug. 29, 2006

Related U.S. Application Data
(63) Continuation of application No. PCT/EP05/02276, filed on Mar. 4, 2005.

(30) Foreign Application Priority Data
Mar. 5, 2004 (DE) 10 2004 010 737.8

(51) Int. Cl. H02P 7/00

(52) U.S. Cl. 318/434

(57) ABSTRACT

A circuit arrangement is provided, including at least one heat-generating power component and means for monitoring the temperature of the circuit arrangement. When a preset limiting temperature is reached, the means for monitoring the temperature reduces the power of the load using the power component by reducing the load current flowing through the power component. An electric switch including such a circuit arrangement is also provided.

### CROSS REFERENCE TO RELATED APPLICATIONS

This application is a continuation of International Application No. PCT/EP2005/002276, having a filing date of Mar. 4, 2005, which designated the United States, and claims the benefit under 37 USC §119(a)-(d) of German Application No. 10 2004 010 737.8, filed Mar. 5, 2004, the entireties of which are incorporated herein by reference.

### FIELD OF THE INVENTION

The present invention relates to an electrical circuit arrangement.

### BACKGROUND OF THE INVENTION

Electrical circuit arrangements are used for open-loop and/or closed-loop control of power which is output by a load. The load can be, for example, an electric motor wherein the circuit arrangement is used for open-loop and/or closed-loop control of the rotational speed and/or torque of the electric motor.

Such an electrical circuit arrangement is composed of electrical and/or electronic components. The components include at least one heat-generating power component such as a power transistor, a MOS-FET, a triac or the like which are used to perform the actual open-loop and/or closed-loop control of the power of the load. This can be done by performing corresponding open-loop and/or closed-loop control of the electrical load current flowing through the power component to the load. Such a circuit arrangement which is accommodated in a switch for a power tool, specifically for an accumulator-type power tool, is presented, for example, in DE 41 14 854 A1.

While the electrical circuit arrangement is operating, heat is generated in the components, particularly in the power component. This generated heat has to be carried away or otherwise dissipated in order to prevent thermal damage to the components which leads to the destruction of the circuit arrangement. It has become apparent, however, that it is not always possible to provide the degree of heat dissipation desired. In particular, in electric switches for high-power power tools, the circuit arrangement provided for performing open-loop control of the rotational speed or for switching off the torque is arranged in a largely closed-off switch housing, and corresponding adverse effects extending as far as the premature failing of the switch have occurred. This problem is particularly relevant in accumulator-type power tools where high currents flow through the switch.

### SUMMARY OF THE INVENTION

The object of the present invention is to protect the electrical circuit arrangement against destruction through overheating even when heat is not sufficiently dissipated. This object is achieved in an electrical circuit arrangement of the generic type by means of the characterizing features of the first embodiment of the present invention.

The circuit arrangement according to the present invention includes means for monitoring the temperature of the circuit arrangement. When a limiting temperature is reached, the means for monitoring the temperature brings about a reduction in the power of the load using the power component, in particular by reducing the load current flowing through the power component. The power of the load therefore begins to be reduced if the temperature within the circuit arrangement rises above a defined value so that overheating and destruction of the circuit arrangement are effectively prevented. The power of the load is expediently reduced to such an extent that the temperature subsequently drops below the limiting temperature again.

The circuit arrangement according to the present invention is usually arranged on a printed circuit board. An IMS (Insulated Metal Substrate) printed circuit board which has excellent thermal conductivity is appropriate as a printed circuit board in order to conduct heat away satisfactorily as an accompanying measure.

The means for monitoring the temperature can be advantageously arranged as a temperature-dependent component such as a temperature sensor for the circuit arrangement itself, and as a result, a direct thermal connection between the sensor and the circuit, and thus to the heat source, is provided. In order to provide good and direct thermal coupling to the power component, the temperature-dependent component can also be arranged on the printed circuit board. In particular, an NTC resistor is appropriate as a temperature-dependent component. The NTC resistor can be easily and cost-effectively applied to the printed circuit board by printing. Depending on whether overload protection is required, the NTC resistor, or a normal resistor, can then be advantageously mounted on the uniform layout of the printed circuit board. As a result, variants of the circuit arrangement can be manufactured with and without overload protection with a low additional expenditure at most.

If the electric motor is operated with DC voltage, the circuit arrangement can be embodied as a pulse-width modulated (PWM) circuit. In order to reduce the power of the load, it is then easily possible to decrease the pulse duty factor of the PWM circuit. The PWM circuit usually has a timer module with an internal voltage divider. The NTC resistor can then be connected with low additional expenditure to the internal voltage divider in order to manipulate the pulse duty factor in the desired way while increasing the temperature at the internal voltage divider.

If the electric motor is operated with AC voltage, the circuit arrangement can be embodied as a leading-edge and/or trailing-edge phase control circuit. In order to reduce the power of the load, it is then easily possible to correspondingly decrease the leading-edge and/or trailing-edge phase.

The present invention can be particularly advantageously used in an electrical switch for a power tool such as an accumulator-type tool and/or mains-type power tool. Such a power tool switch includes a circuit arrangement which is embodied as an electronic power system and which performs open-loop and/or closed-loop control of the rotational speed of the electric motor for the power tool, and the electronic power system is frequently located in the housing of the power tool switch for the sake of compactness. If the power tool is operated by means of the electronic power system for too long, the electronic power system can become overheated and destroyed if the heat is not sufficiently dissipated. In order to prevent overheating of the electronic system, the power tool switch is also provided with a temperature monitoring means, and according to the present invention, when a predefined limiting temperature of the circuit arrangement is reached in the power tool switch, the rotational speed is reduced so that the electronic power system in the power tool switch is effectively protected against overheating.

If appropriate, in this case, the user will completely activate the power tool switch in order to again obtain the desired or necessary power of the power tool. However, the bypass contact which is generally provided in the switch then switches on, causing the electronic power system to be bypassed and the full voltage to be applied to the electric motor which is now operated without closed-loop control. Since the bypassed electronic power system is not operational in this case, it can then cool down again. Consequently, if the user does not desire a reduced but rather an essentially constant power of the power tool, he is automatically forced to bypass the electronic power system, which ultimately then protects it.

The particular advantages achieved with the invention include the ability to obtain a closed closed-loop control circuit to protect the circuit arrangement, and in particular the electronic power system in a power tool switch, against overheating. Nevertheless, this is a simple and cost-effective way of implementing this overload protection. Furthermore it permits less powerful, and thus more cost-effective, power components to be used due to the protection function which is achieved according to the invention.

### BRIEF DESCRIPTION OF THE DRAWINGS

An exemplary embodiment of the invention with various developments and refinements is illustrated in the drawings and will be described in more detail below. In the drawings:

FIG. 1 is a side view of an electric switch;

FIG. 2 is a sectional view of the electric switch shown in FIG. 1 taken along the line A-A in FIG. 1; and

FIG. 3 is a circuit diagram of a circuit arrangement embodied as a pulse-width-modulated circuit.

### DETAILED DESCRIPTION OF THE INVENTION

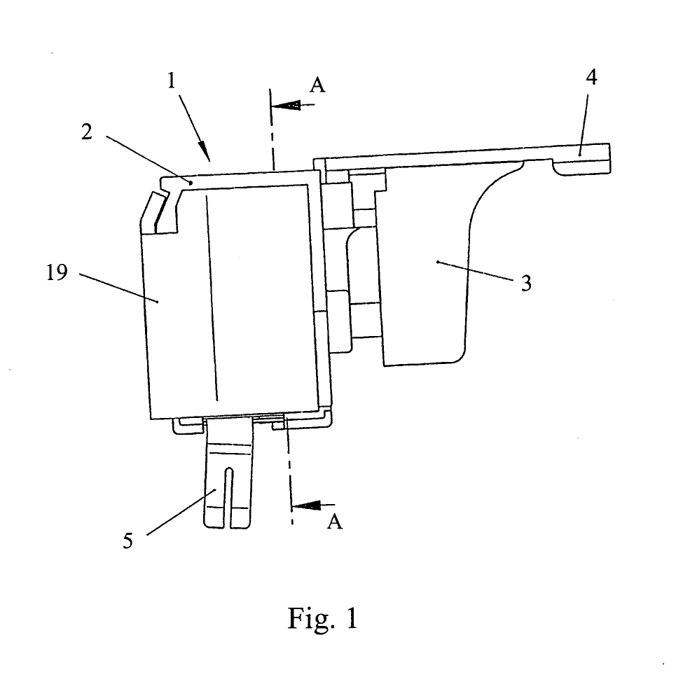

FIG. 1 shows an electrical switch 1 which is to be used for a power tool with an electric motor, to be precise in particular for an accumulator-type power tool which is operated with DC voltage. The switch 1 has a housing 2, an activation member 3, which is shown as a pushbutton switch and which is moveably arranged on the housing 2 for the manual activation of the power tool by the user, an activation element 4, which is shown as a switchover lever for switching over the right-left running direction of the power tool, and connecting terminals 5 which are arranged on the housing 2 and provide an electrical connection to the accumulator. Of course, given the appropriate configuration, which will also be described briefly below, such a switch 1 can also be used for a mains power tool which is operated with alternating voltage.

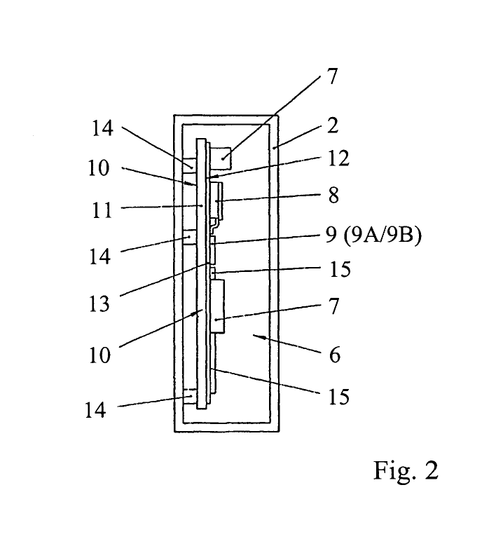

As shown schematically in FIG. 2, an electrical circuit arrangement 6 is arranged in the housing 2. The electrical circuit arrangement 6 is embodied as an electronic power system and has the purpose of performing open-loop and/or closed-loop control of the rotational speed of the electric motor, which acts as a load, in the power tool. The circuit arrangement 6 can also include a means for performing open-loop control of the torque, preferably for switching off the torque of the electric motor. The means can be used, for example, for screwing operations with the power tool, or can include such a functionality of the power tool. The circuit arrangement 6 thus contains at least part of the electronic control system for the electric motor of the power tool. The housing 2 also accommodates additional parts of the switch 1 such as a contact system or the like, but these components are not further illustrated.

The circuit arrangement 6 has an electrical and/or electronic component 7. These also include at least one power component 8 during whose operation dissipated heat is generated. The power component 8 is a power transistor or MOS-FET for performing open-loop and/or closed-loop control of the power of the load. This open-loop and/or closed-loop control is usually carried out by appropriately performing open-loop and/or closed-loop control of the electrical load current which flows through the power component 8 to the load. In the circuit arrangement 6, a means 9 for monitoring the temperature is provided such that when a preset limiting temperature is reached, the means 9 for monitoring the 4 temperature reduces the power of the load using the power component 8. This is expediently done by reducing the load current flowing through the power component 8. The power of the load is preferably reduced to such an extent that the temperature subsequently drops below the preset limiting temperature again. Consequently, when the limiting temperature of the circuit arrangement 6 is reached, the rotational speed of the electric motor in the power tool is therefore reduced, and unacceptable heating of the circuit arrangement 6 is thus reliably avoided. In order to reduce fluctuations in the rotational speed in the critical range of the limiting temperature, the rotational speed can be adapted with a type of hysteresis.

As further shown in FIG. 2, the circuit arrangement 6 is arranged on a printed circuit board 10. The printed circuit board 10 can be configured as an IMS (Insulated Metal Substrate) printed circuit board, which has particularly good heat-conducting properties. Such an IMS printed circuit board is composed of a metal part 11 having an electrically insulating coating on the surface 12 thereof which faces the components 7. The conductor tracks 15 for the electrical connection of the components 7 are applied in a known fashion to the coating 13. The printed circuit board 10 is attached in the housing 2 by means of holding elements 14. In order to improve the conduction of heat away from the housing 2, the printed circuit board 10 can be connected in a known fashion to a heat sink 19 which is attached, for example, to the outside of the housing 2.

The means 9 for monitoring the temperature has a temperature-dependent component 9A which is arranged on the printed circuit board 10 with direct thermal coupling to the power component 8. For this purpose, the temperature-dependent component 9A is located in the direct vicinity of the power component 8, as shown in FIG. 2, so that the temperature-dependent component 9A can most accurately detect the temperature of the power component 8. In an IMS printed circuit board 10, the metal part 11 ensures that there is good thermal coupling so that the temperature-dependent component 9A can also be easily removed from the power component 8 in terms of various appropriate criteria. In particular, an NTC resistor whose electrical resistance changes as a dependent function of the temperature is a suitable example for the temperature-dependent component 9A. The NTC resistor 9B can be applied to the coating 13 of the printed circuit board 10 by printing, essentially by means of the same technology as the conductor tracks 15.

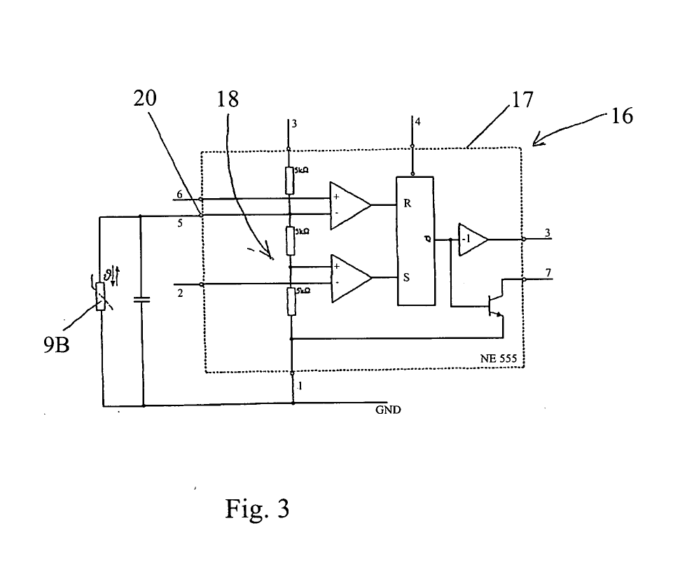

In the case of a power tool which is operated with DC voltage, it is appropriate for the circuit arrangement 6 to be embodied as a pulse-width-modulated (PWM) circuit 16. The circuit diagram for such a PWM circuit 16 is given schematically in FIG. 3. The PWM circuit 16 has a timer module 17 as an integrated circuit. For example, the timer module 17 can be a known chip such as one having a designation NE555. This timer module 17 has an internal voltage divider 18. In order to reduce the power of the load, it is then possible to easily decrease the pulse duty factor of the PWM circuit 16. For this purpose, the external NTC resistor 9B is preferably connected via corresponding inputs 20 of the timer module 17 to the internal voltage divider 18.

In a power tool which is operated with AC voltage, it is appropriate for the circuit arrangement 6 to be embodied as a leading-edge and/or trailing-edge phase control circuit, in which case the power component 8 is composed of a triac or the like. Such leading-edge and/or trailing-edge phase control circuits are known per se so that they do not need to be shown further. In order to reduce the power of the load, the leading-edge and/or trailing-edge phase is then correspondingly decreased.

The present invention is not limited to the exemplary embodiment illustrated and described herein as a circuit arrangement 6 in the housing 2 of the electric switch 1. This circuit arrangement 6 can equally well also be arranged per se at any other expedient location in the power tool. The present invention can not only be used for electrical switches and for power tools, but also in many other heat-generating circuit arrangements for control units, domestic appliances, electric gardening equipment, machine tools, dimmable lamps or the like.

### LIST OF REFERENCE NUMERALS

1: Electrical switch
2: Housing
3: Activation member
4: Activation element
5: Connecting terminal
6: Circuit arrangement
7: Component
8: Power component
9: Means for monitoring the temperature
9A: temperature-dependent component
9B: NTC resistor
10: Printed circuit board/IMS printed circuit board
11: Metal part
12: Surface (of metal part)
13: (Insulating) coating (on metal part)
14: Holding means (for printed circuit board)
15: Printed circuit board
16: Pulse-width-modulated circuit
17: Timer module
18: Voltage divider (of timer module)
19: Heat sink
20: Input (of timer module)

What is claimed:

1. An electrical circuit arrangement for performing at least one of an open-loop and a closed-loop control of an electric motor, the electrical circuit arrangement comprising:
at least one heat-generating power component capable of controlling the power of a load by correspondingly performing at least one of the open-loop and closed-loop control of an electrical load current flowing through the power component to the load; and
means for monitoring a temperature of the circuit arrangement provided such that when a preset limiting temperature is reached, the means for monitoring the temperature operates to effectively reduce the power of the load by reducing the load current flowing through the power component.

2. The electrical circuit arrangement of claim 1, wherein the means for monitoring temperature enables the power of the load to be reduced such that the temperature subsequently drops below the preset limiting temperature.

3. The electrical circuit arrangement of claim 1, wherein the circuit arrangement is arranged on a printed circuit board.

4. The electrical circuit arrangement of claim 1, wherein the means for monitoring the temperature includes a temperature-dependent component.

5. The electrical circuit arrangement of claim 1, wherein the circuit arrangement comprises a pulse-width modulation (PWM) circuit, and wherein a pulse duty factor of the PWM circuit is decreased in order to reduce the power of the load.

6. The electrical circuit arrangement of claim 5, wherein the PWM circuit has a timer module with an internal voltage divider, and wherein a temperature-dependent component of the means for monitoring the temperature is preferably connected to the internal voltage divider.

7. The electrical circuit arrangement of claim 1, wherein the circuit arrangement comprises one of a leading-edge and a trailing-edge phase control circuit, whereby the respective leading-edge or trailing-edge phase is decreased in order to reduce the power of the load.

8. An electrical switch for power tools, the electrical switch comprising the electrical circuit arrangement of claim 1;
wherein the electrical circuit arrangement controls a rotational speed of electric motor of the power tool so that when the preset limiting temperature of the circuit arrangement is reached, the rotational speed is reduced.

9. The electrical circuit arrangement of claim 1, wherein the at least one heat-generating power component comprises one of a power transistor, a MOS-FET and a triac.

10. The electrical circuit arrangement of claim 3, wherein the printed circuit board comprises an insulated metal substrate (IMS) printed circuit board.

11. The electrical circuit arrangement of claim 4, wherein the temperature-dependent component comprises an NTC resistor.

12. The electrical circuit arrangement of claim 4, wherein the temperature-dependent component is arranged on a printed circuit board with direct heat coupling to the power component.

13. The electrical circuit arrangement of claim 12, wherein the temperature-dependent component comprises an NTC resistor that is formed on the printed circuit board by printing.
